(19) United States
(12) Patent Application Publication
(10) Pub. No.: US 2020/0088832 A1
(43) Pub. Date: Mar. 19, 2020

(54) Gunshot Detection System

(71) Applicant: Active Guardian, Oconomowoc, WI (US)

(72) Inventor: Brad Jarrett, Woodstock, GA (US)

(21) Appl. No.: 16/421,652

(22) Filed: May 24, 2019

Related U.S. Application Data
(60) Provisional application No. 62/675,829, filed on May 24, 2018.

(51) Int. Cl. G01S 3/808; G01S 3/802

(52) U.S. Cl. CPC G01S 3/8083; G01S 3/8027

(57) ABSTRACT

A gunshot detection system utilizes an ultrasonic transducer for detecting a blast wave resulting from a gunshot. The system may be linked to alert systems configured for notifying emergency response personnel to the occurrence and location of a gunshot, thereby enabling a rapid response to an active shooter situation.

### CROSS-REFERENCE TO RELATED APPLICATIONS

This application claims the benefit of U.S. Provisional Patent Application Ser. No. 62/675,829, filed May 24, 2018, the disclosure of which is incorporated by reference in its entirety and commonly owned.

### FIELD OF THE INVENTION

The present invention generally relates to systems and methods for detecting a gunshot, and more particularly, to systems and methods employing a transducer to detect a concussion wave resulting from a gunshot.

### BACKGROUND

Gun violence is a substantial and increasing threat to individuals in the United States. The ability of emergency response personnel to respond quickly to an active shooter situation is critical to protecting the public from imminent harm or death. Existing gunshot detection systems typically employ a microphone configured to constantly record an area coupled with software for analyzing the audio signal and assessing whether an audible sound is consistent with the occurrence of a gunshot. In many instances, however, the audio signal needs to be monitored by a person and/or subjected to an after-the-fact analysis to determine whether a gunshot has been detected, which introduces error and delay into the system. Moreover, existing systems rely on personnel and/or software operating at a location remote from the site of detection, which contributes to a lag or delay in responding to an active shooter event. Existing systems also have limited outdoor effectiveness due to, for example, ambient noise, a lightning strike, fireworks, or construction noise and the like, which can mask or obscure the sound of a gunshot. The cost of detecting gunshots by other systems is inherently increased due to back room servers, cloud servers, and/or processors needed to analyze the audio signal. The embodiments disclosed herein are aimed at overcoming these and other limitations in the art.

### SUMMARY

Embodiments of the present disclosure include gunshot detection systems that detect the characteristic concussion wave that originates from a gunshot. Unlike existing systems, which rely on the capture of audio signals with a microphone, one or more of the present embodiments utilize an ultrasonic transducer in coordination with other hardware and/or software components to detect gunshot concussion waves, thereby circumventing the undesirable delays and other limitations associated with existing systems. Exemplary systems disclosed herein enable a gunshot detection unit to determine the occurrence of a gunshot in real time at the point of detection, rather than relying on an after-the-fact analysis of a pre-recorded audio signal. By reducing detection time, the disclosed systems reduce emergency personnel response time to an emergency situation.

The embodiments disclosed herein perform analytics via low cost onboard electronic components and custom firmware. No additional hardware is required to determine an occurrence of a gunshot or relay the information to host security systems. In addition, because one or more embodiments comprise 2.4 Ghz wireless communications between the main and auxiliary units, no network or connective wiring is required, reducing installation time and cost.

### BRIEF DESCRIPTION OF THE DRAWINGS

Embodiments of the invention are described by way of example with reference to the accompanying drawings in which:

FIG. 1 depicts an exemplary wiring diagram of an embodiment of the gunshot detection unit of the present disclosure;

FIG. 2 depicts an exemplary wiring diagram of a sensor associated with a gunshot detection unit of the present disclosure;

FIG. 3 depicts an external perspective view of an exemplary gunshot detection unit of the present disclosure;

FIG. 4 depicts an internal support structure in accordance with one or more embodiments of the present disclosure; and

FIGS. 5A and 5B depict exemplary circuit board layouts in accordance with one or more embodiments of the present disclosure.

### DETAILED DESCRIPTION OF EMBODIMENTS

The present invention will now be described more fully hereinafter with reference to the accompanying drawings, in which embodiments of the invention are shown by way of illustration and example. This invention may, however, be embodied in many forms and should not be construed as limited to the embodiments set forth herein. Rather, these embodiments are provided so that this disclosure will be thorough and complete, and will fully convey the scope of the invention to those skilled in the art. Like numerals refer to like elements.

One or more embodiments of the present disclosure comprise a concussion-based gunshot detection system capable of immediate incident reporting to emergency response personnel. Embodiments of the system may utilize at least one of a primary and/or an auxiliary sensor unit(s), an internet network “gateway” with setup and monitoring software, IP cameras, and/or a cloud-based or other web portal for managing and coordinating the components of the system.

The primary and/or auxiliary sensor unit(s), also herein referred to as a gunshot detection unit or module, may comprise one or more concussion sensors, such as, for example, an ultrasonic transducer. The transducer detects the concussion wave from a gunshot and converts the signal to an analog signal, which is sent to a multiplexor which in turn sends the data to a microprocessor. The microprocessor contains firmware that analyzes the data to determine if a gunshot has occurred within the detecting area.

If the signal reaches a predetermined threshold consistent with the occurrence of a gunshot, the gunshot detection unit sends (via USB or Bluetooth) an alert notification directly to a secondary device configured for initiating an emergency response protocol, such as an alarm system, video system, monitoring system, dispatch system, or other suitable system for alerting an individual to the gunshot. In one or more embodiments, a colored LED or other notification means, such as an alarm or siren, is activated when a gunshot is detected. A colored LED or other notification means may also be used to indicate that a loud noise did not originate from a gunshot.

In one or more alternative embodiments, the gunshot detection unit may connect to at least one of a secondary unit or gateway unit via USB, Bluetooth, Ethernet with POE, or other suitable connection means. In embodiments employing a gateway unit, the gateway unit acts as an intermediary device between the gunshot detection unit(s) and a pre-existing or pre-established alert system or secondary device or system. In one or more embodiments, the connection between the gunshot detection unit and the secondary device and/or gateway is via USB (e.g. virtual Com Port). This connectivity provides a plug-and-play environment without requiring the need for setting up networks between multiple gunshot detection units and the gateway. Auxiliary, or secondary, gunshot detection units configured for communicating therebetween may also be deployed to increase an effective gunshot detection area. Connectivity between components of the system may be via any suitable means, including but not limited to four-wire RJ11 connections on the main and auxiliary device(s).

In one or more embodiment, at least one of the gunshot detection unit and a gateway is configured for collecting and analyzing data or signal(s) received by the gunshot detection unit(s). The gunshot detection unit(s) and the gateway may be configured for Ethernet and/or wireless connectivity to a network. In one or more embodiments, at least one of the gunshot detection unit and the gateway comprises multiple USB ports. In one or more embodiments, when the gateway is on the same network as an IP or other camera system or network, the software can detect and connect to one of the associated RTSP streams of multiple cameras simultaneously. This interoperability between the system and a camera network enables the immediate and automatic recording of an area wherein a gunshot has been detected by the system.

In one or more embodiments, the gunshot detection unit employs a sensor that continuously monitors a site for a concussion wave characteristic of a gunshot. In one or more embodiments, the occurrence of a gunshot automatically activates at least one of the sensor (such as a transducer) and the system. If a gunshot concussion wave is detected, the gunshot detection module automatically sends a command to at least one of an alert system and a networked camera system to capture images of the scene. Once the images are sent to the cloud or other suitable location, they are compiled into an actionable intelligence report and sent to emergency contact numbers on file or other emergency response personnel via a secure link(s).

The software may also connect multiple gunshot detection units and/or the gateway via USB or Bluetooth. In one or more embodiments, the system may be programmed to report to a hosting server upon an occurrence of at least one of the following events: main and/or auxiliary health-check every 60 minutes; loud noise detected; and gunshot detected (includes at least one of alarm info, unit(s) location, and sensor position number).

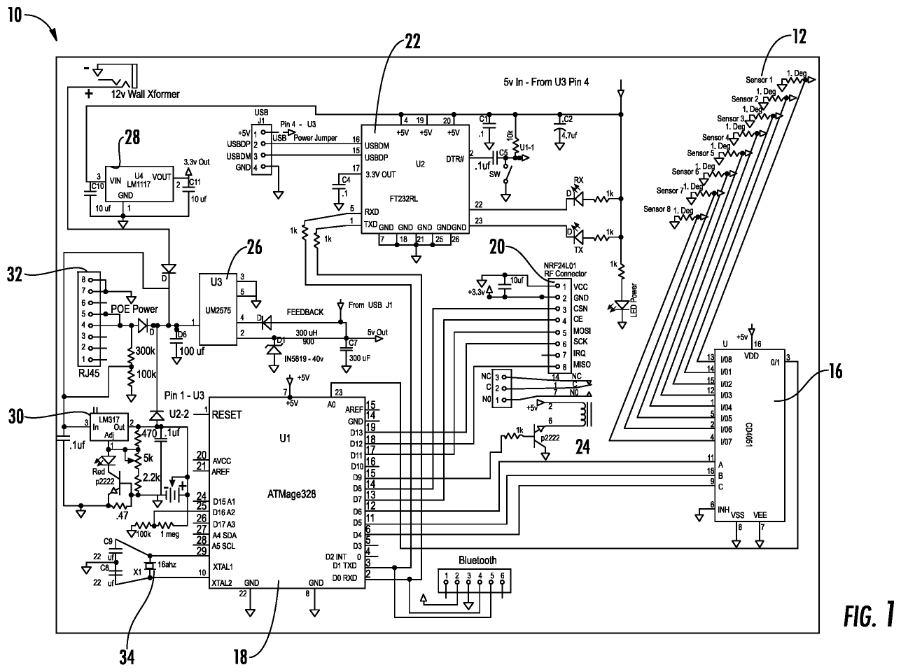

As depicted in FIGS. 1-3, one or more embodiments of the present disclosure include a gunshot detection system comprising a gunshot detection unit 10 (also herein referred to as a gunshot detection module) having a sensor 12 comprising at least one ultrasonic transducer 14 for detecting a concussion wave originating from a gunshot. The gunshot detection unit 10 detects a gunshot and sends data to any VMS, video, and/or alarm system.

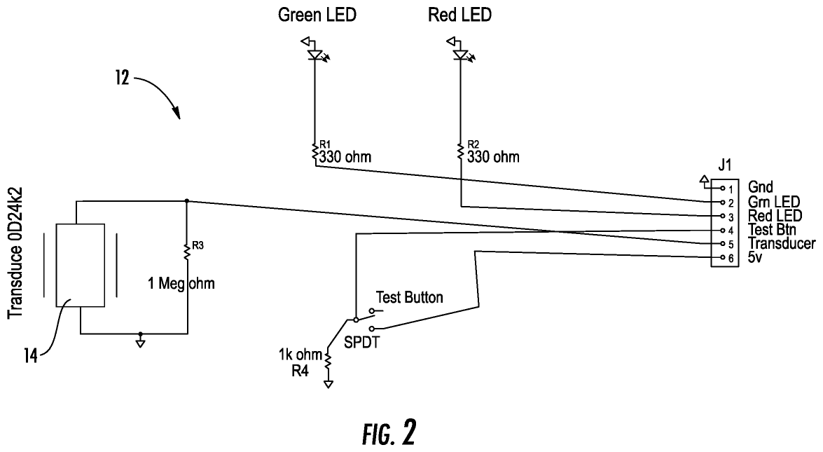

In one or more embodiments, detection occurs via a sensor 12 employing an ultrasonic transducer 14 and the associated circuitry as depicted in FIGS. 1-2. In this exemplary embodiment, and as depicted in FIG. 1, an eight-channel multiplexor 16 consistently listens for any analog signal from each of the eight sensors 12 and sends any and all information to the microprocessor 18. The microprocessor 18 utilizes firmware loaded into the processor for analyzing any data coming from the multiplexor 16 and/or an RF radio 20 and determining whether a gunshot has been detected. The RF radio 20 also receives data from any associated auxiliary sensors, processes the information, and sends to FTDI USB IC 22, which then communicates the results to the paired hosting or alert system, which has been linked beforehand to the gunshot detection system. An example of a paired hosting or alert system is a system comprising integrated cameras configured for recording the event and sending the information to any necessary recipients, such as law enforcement, security, or other emergency response personnel.

The FTDI USB 22 is a bus chip that receives data from the processor 18 and sends the information over a USB serial data connection. It is also used to program the microprocessor 18 from a PC with any suitable software loader.

A dry contact relay 24 may also be provided. If a gunshot is detected, the processor sends a signal to energize this relay which, in turn, if connected to an alarm panel, will trip the alarm circuit.

One or more embodiments may also comprise a power converter 26 to convert any power over 48 v down to 5 v to operate the board circuits; a power converter 28 to convert the 5 v to 3.3 v to operate the RF Radio 20; and/or a 3 v regulator 30 to charge the onboard CR123 batteries.

One or more embodiments may comprise POE (power over ethernet) 32 to provide power to the board if connected to a POE Switch, and/or a 16 MHz crystal 34 to maintain the timing of the microprocessor's operations and functions.

Contrary to preexisting systems, which use audio/acoustic microphones, dissect the soundwave, and then determine if a sound is a gunshot by relying on programs running on servers, cloud or local, to do the analytics, all analytics associated with the gunshot detection unit 10 of the present disclosure are done through specialized circuitry and associated firmware onboard the unit, thereby providing an ability to detect and alert to the occurrence of a gunshot in near real-time, while simultaneously increasing the accuracy of gunshot detection.

In one or more embodiments, the firmware consistently “spins” the 8-channel multiplexor 16, which is waiting for a signal from any of the eight transducers 14. The firmware determines the number of the sensor by the channel of the multiplexor 16 receiving the concussion event. When the data signal is received by the microprocessor 18 from the multiplexor 16, the firmware quickly converts the signal via a predetermined level number scheme. The firmware then checks the level number against a custom designed algorithm to determine if it is a gunshot or just ambient noise.

If the firmware determines it is in fact a gunshot, the firmware then compiles the data into simple text with at least one of the following information: unit number, sensor number, and level of intensity. The firmware then sends the text to the FTDI USB chip, which in turns sends it out the USB/Serial port to the hosting computer or device.

By way of non-limiting example, the ultrasonic transducer 14 of an embodiment of the gunshot detection unit detects concussive airwaves at a frequency between about 10 khz and about 100 kHz, which is the frequency range of a gunshot concussion wave (or “blast wave”) resulting from the explosion of gunpowder and a bullet leaving the chamber of a firearm. This concussion wave turns on the transducer 14, which converts the energy of the blast wave into an analog signal and determines whether the analog signal is consistent with a gunshot based on a comparison to a predetermined criteria. Events such as thunder, a car backfiring, an air horn, or other loud noises are not on the blast wave's frequency, and therefore the shockwaves associated with these types of typical background events are not strong enough or have the proper frequency to activate the transducer. Embodiments wherein a gunshot automatically activates the transducer have the added advantage over existing systems of preserving battery life, thereby further increasing the effectiveness and reliability of the system.

The gunshot detection unit may provide a first indication in the event the concussion did not originate from a gunshot, and/or a second indication in the event the concussion originated from a gunshot. The first and second indications may be determined internally within the gunshot detection unit by the incorporated circuitry based upon an output (analog or otherwise) from the at least one ultrasonic transducer.

For instance, once a concussion wave is detected by the transducer, the gunshot detection unit converts the signal to an analog signal. If the signal reaches a predetermined threshold consistent with a gunshot, then an alert is sent. If the analog signal does not reach a predetermined threshold, the unit does not send an alert. Alternatively, a separate non-gunshot alert may also be provided.

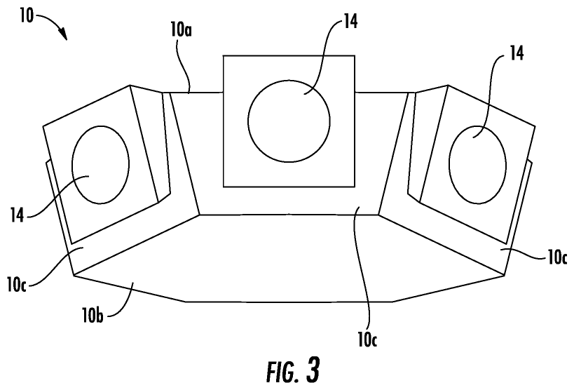

In one or more embodiments, the gunshot detection unit 10 comprises more than one ultrasonic transducer 14. The ultrasonic transducers 14 may all be oriented along the same axis. Alternatively, the transducers may be oriented along a plurality of similar or varying axes. In one or more embodiments, each ultrasonic transducer is angled at about 22 degrees relative to a surface of the gunshot detection unit. For instance, and as depicted in FIG. 3, a gunshot detection unit 10 having an upper surface 10a for being mounted flat on the ceiling of a room may comprise transducers 14 arranged in a circular manner and oriented downward at an angle of about 22 degrees relative to the ceiling surface. Thus, a unit ten feet or higher still points the transducers towards a shooter below, thereby maximizing the unit's detection range and area.

When multiple transducers are arranged circumferentially around a gunshot detection unit, the system can determine the direction from which the concussive wave originated by comparing the intensity (and resultant signal) of the concussion waves detected by the various transducers, thereby enabling an approximation of the location of the shooter. As will be appreciated by one of ordinary skill in the art having the benefit of the present disclosure, the placement of multiple gunshot detection units throughout a defined area, or boundary, enables a triangulation of the location of the shooter.

With continued references to FIG. 3, one or more embodiments of the present disclosure include a gunshot detection unit 10 comprising a body portion having an upper surface 10a, a lower surface 10b, and a peripheral surface 10c therebetween. At least one ultrasonic transducer 14 extending from one of the surfaces of the body portion may be included in the gunshot detection unit.

In one or more embodiments, the peripheral surfaces 10c are arranged octagonally, and thereby comprises eight surfaces in eight distinct planes, respectively. One of ordinary skill in the art having the benefit of the present disclosure will appreciate that other suitable configurations, including hexagonal, pentagonal, square, triangular, circular, oval, spherical, a dome, cylindrical, or any other suitable configurations, are within the scope of the present disclosure. In embodiments having an octagonally-arranged peripheral surface, the at least one ultrasonic transducer may comprise an individual ultrasonic transducer extending from or through each of the eight surfaces, respectively.

In one or more embodiments, a detecting surface of a portion of the at least one ultrasonic transducer is oriented at an angle of about 22 degrees relative to the upper surface. Other angular orientations, including but not limited to 0-10 degrees, 10-20 degrees, 20-30 degrees, 30-40 degrees, 40-50 degrees, 50-60 degrees, 60-70 degrees, 70-80 degrees, 80-90 degrees, and 90-360 degrees are considered to be within the scope of the present embodiments.

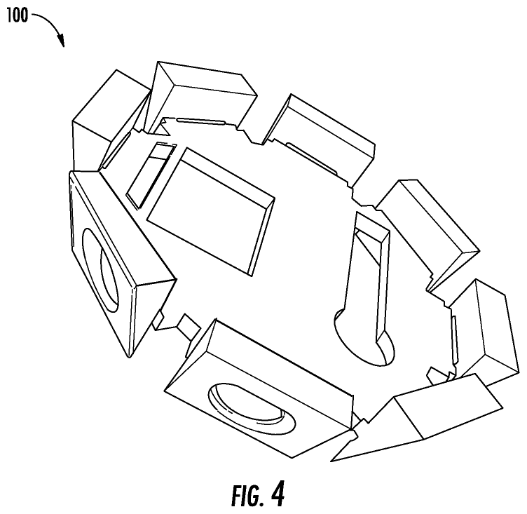

As depicted in FIG. 4, one or more embodiments of the gunshot detection unit may comprise an insert 100 for supporting the sensors (and associated transducers) and the hardware and associated circuitry utilized by the system. The angle at which the sensors are oriented may be defined by the insert, as is the case in the exemplary embodiment of FIG. 4, which angles the sensors downward at an angle of about 22 degrees from a central plane or surface of the housing when installed in the housing, or body portion.

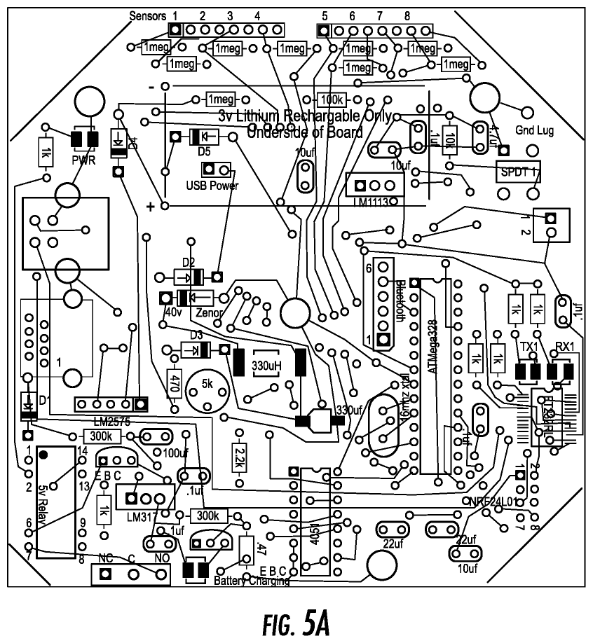

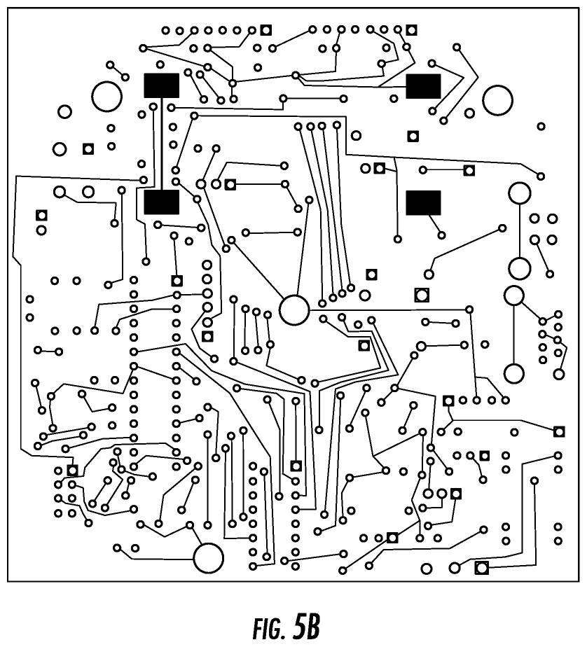

In one or more embodiments, the body portion houses at least one component for determining whether a gunshot has been detected by the at least one transducer. For example, the at least one component may comprise at least one of the components disclosed in FIGS. 1-2 and the associated description herein. Moreover, the circuit boards may be configured as depicted in FIGS. 5A (top) and 5B (bottom).

In one or more embodiments, the system may further comprise a plurality of additional, or auxiliary, gunshot detection units configured for communicating therebetween. By adding additional units to the system, a user can increase the effective detection area of the system. For example, multiple units can be placed in various rooms of a building, or at various locations in a public or private space so as to enable the detection of gunshots throughout a complex location. The embodiments disclosed herein are useful indoors and outdoors due to their immunity to non-gunshot-related background noise. For example, the embodiments disclosed herein can detect a single gunshot at a loud sporting event or concert, as well as in a school, public building, restaurant, or other location where the ability to rapidly and accurately detect a gunshot is desirable.

One or more embodiments of the present disclosure may comprise a gateway unit (not shown) configured for receiving information from at least one gunshot detection unit and transmitting the information to another device for alerting emergency response personnel. For example, the gateway may be configured for receiving at least one of the first indication and the second indication directly from the gunshot detection unit. Further, at least one of the gunshot detection unit and the gateway unit may be configured for transmitting information relating to at least one of the first and second indications to law enforcement personnel or another suitable third party.

One or more embodiments of the present disclosure also comprise a method for detecting a gunshot, the method comprising (i) receiving, by a gunshot detection unit having an ultrasonic transducer, an ultrasonic wave; (ii) determining, by the gunshot detection unit, whether the ultrasonic wave originated from a gunshot; (iii) generating, in response to the determining step, at least one of a first indication and second indication, wherein the first indication corresponds to an absence of a gunshot, and wherein the second indication corresponds to the presence of a gunshot; and (iv) transmitting, by the gunshot detection unit, at least one of the first and second indications.

In one or more embodiments, the ultrasonic wave has a frequency between about 10 khz and about 100 khz. Further, the determining may comprise determining whether an analog signal provided by the ultrasonic transducer is greater than or equal to a predetermined threshold, or alternatively, whether an analog signal provided by the ultrasonic transducer is less than a predetermined threshold.

A method may further comprise receiving, by a gateway unit, at least one of the first indication and the second indication, and still further comprise transmitting, by the gateway unit, at least one of the first indication and the second indication.

Although the invention has been described relative to various selected embodiments herein presented by way of example, there are numerous variations and modifications that will be readily apparent to those skilled in the art in light of the above teachings. It is therefore to be understood that, within the scope of the claims hereto attached and supported by this specification, the invention may be practiced other than as specifically described.

What is claimed is:

1. A gunshot detection system, comprising:
a gunshot detection unit having at least one ultrasonic transducer for detecting a concussion wave, the gunshot detection unit providing at least one of a first indication and a second indication, wherein the first indication corresponds to an absence of a gunshot, and wherein the second indication corresponds to the occurrence of a gunshot.

2. The system of claim 1, wherein the first and second indications are determined by the gunshot detection unit based an output from the at least one ultrasonic transducer.

3. The system of claim 1, wherein the gunshot detection unit comprises more than one ultrasonic transducer.

4. The system of claim 3, wherein each ultrasonic transducer is positioned along the same axis.

5. The system of claim 4, wherein each ultrasonic transducer is angled at about 22 degrees relative to a surface of the gunshot detection unit.

6. The system of claim 1, further comprising a plurality of additional gunshot detection units configured for communicating therebetween.

7. The system of claim 1, further comprising a gateway unit configured for receiving at least one of the first indication and the second indication from the gunshot detection unit.

8. The system of claim 7, wherein at least one of the gunshot detection unit and the gateway unit is configured for transmitting information relating to at least one of the first and second indications to emergency response personnel.

9. A method for detecting a gunshot, the method comprising;
receiving, by a gunshot detection unit having an ultrasonic transducer, an ultrasonic wave;
determining, by the gunshot detection unit, whether the ultrasonic wave originated from a gunshot;
generating, in response to the determining step, at least one of a first indication and second indication, wherein the first indication corresponds to an absence of a gunshot, and wherein the second indication corresponds to the presence of a gunshot; and
transmitting, by the gunshot detection unit, at least one of the first and second indications.

10. The method of claim 9, wherein the ultrasonic wave has a frequency between about 10 kHz and about 100 kHz.

11. The method of claim 9, wherein the determining comprises determining whether an analog signal provided by the ultrasonic transducer is greater than or equal to a predetermined threshold.

12. The method of claim 9, wherein the determining comprises determining whether an analog signal provided by the ultrasonic transducer is less than a predetermined threshold.

13. The method of claim 9, further comprising receiving, by a gateway unit, at least one of the first indication and the second indication.

14. The method of claim 13, further comprising transmitting, by the gateway unit, at least one of the first indication and the second indication.

15. A gunshot detection unit, comprising:
a body portion having an upper surface, a lower surface, and a peripheral surface therebetween; and
at least one ultrasonic transducer extending from one of the surfaces of the body portion.

16. The gunshot detection unit of claim 15, wherein the peripheral surface is arranged octagonally, and thereby comprises eight surfaces in eight distinct planes, respectively.

17. The gunshot detection unit of claim 16, wherein the at least one ultrasonic transducer comprises an ultrasonic transducer extending from each of the eight surfaces, respectively.

18. The gunshot detection unit of claim 15, wherein a portion of the at least one ultrasonic transducer is oriented at an angle of about 22 degrees relative to the upper surface.

19. The gunshot detection unit of claim 15, wherein the body portion houses at least one component for determining whether a gunshot has been detected by the at least one transducer.

20. The gunshot detection unit of claim 19, wherein the at least one component is supported by an octagonal insert.
